(19) United States
(12) Patent Application Publication
(10) Pub. No.: US 2009/0057217 A1
(43) Pub. Date: Mar. 5, 2009

(54) Apparatus for contaminant recovery

(75) Inventors: John M. Bartha, Carpinteria, CA (US); Gyorgy Csapo, Boszormenyi (HU)

Correspondence Address: STETINA BRUNDA GARRED & BRUCKER, 75 ENTERPRISE, SUITE 250, ALISO VIEJO, CA, 92656, US

(73) Assignee: Seawax International, Inc.

(21) Appl. No.: 11/899,252

(22) Filed: Sep. 5, 2007

(51) Int. Cl. C02F 1/40; B08B 3/10

(52) U.S. Cl. 210/209; 134/118; 134/93; 210/242.3; 210/923

(57) ABSTRACT

A contaminant recovery apparatus may have a sprayer attached to a front portion of the apparatus and operative to delivery droplets of molten wax to oil spilled in water or on ground. The apparatus may further comprise a take up system which picks up wax after it has solidified and absorbed the oil. The take up system may be attached to the rearward portion of the apparatus. The apparatus may also have a separation system which separates the wax and the oil. The reclaimed wax can be reused to pick up more spilled oil. The reclaimed oil may be refined for fuel.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is related to an apparatus for recovering oil spilled on land or in water.

Every day oil tankers ship oil around the globe. In the process of shipping oil to various parts of the world, the oil tanker due to poor maintenance, accidents, or other reasons, may spill oil into the ocean. Once oil is spilled into the ocean, oil recovery teams begin to strategize and implement plans to remove and/or recover the oil. The particular oil recovery method implemented will depend on environmental factors, elapsed response time, and other factors. For example, the oil and ocean water composition may limit the types of oil recovery method available. Winter spills may require different methods of oil recovery compared to oil spills during summer. The various environmental factors and other factors limit the types of oil recover methods available for dealing with the oil spill at hand.

One method of oil recovery is skimming. In the skimming method, the surface of the water is skimmed. Oil being lighter than water tends to initially float on the water. A skimmer removes a top portion of the fluid in the hopes of capturing the oil floating thereon. Unfortunately, skimming oil off of the water's top surface is time consuming. Also, if the oil recovery team does not quickly respond to the oil spill, the oil may dissolve or mix into the water rendering the skimming method useless. Accordingly, the skimming method may not be useful in certain situations that may require a long delay before an oil recovery team can begin oil recovery.

Sorbents are another method of recovering oil. As discussed above, the oil initially tends to float on the top surface of the water. Sorbent material encapsulated within a permeable tube may be attached end to end and disposed in the water to surround the oil spill. This provides a physical barrier to prevent the oil spill from expanding into uncontaminated areas. Additional sorbents may be disposed on top of the affected water. These sorbents may soak up the oil. Unfortunately, recovery of oil via sorbents may be cumbersome because the sorbents must be stored, transported, distributed and collectedrequiring a great deal of man power. Moreover, the contaminated sorbents are now toxic and must be properly disposed of. The contaminated sorbents also tend to absorb water and sink after prolonged emersion. This adds an additional labor load because personnel must keep track of all the sorbents and ensure that the sorbents do not stay emersed in the water for too long. Sorbents are also not very efficient because sorbents absorb approximately the same amount of water and oil. Due to these limitations, sorbents are generally used for small scale applications with limited performance.

Another method of treating oil spills in the ocean is to disperse the spilled oil in the ocean such that the environment itself can biodegrade and oxidate the spilled oil and restore the affected area back to its natural condition. The dispersant method requires that laboratory tests be performed to find a suitable dispersant agent for the specific spill. The dispersant agent reduces the surface tension between oil and water and breaks the oil into tiny droplets and suspends them in the water. Unfortunately, there are many deficiencies associated with the dispersant method. For example, laboratory studies on ecological consequences on various dispersants suggest that mixtures of oil and dispersants may be more toxic to the environment than oil alone. Commercial fisheries may be prohibited from selling fish from an affected area. The dispersant method also has certain limitations. For example, the dispersant method may not work for oil spills that contain a significant portion of volatile hydrocarbons (light ends). Dispersants do not work in sweet or low salinity waters and are not dispersible in cold or shallow waters and are not effective on the areas having a viscosity greater than two thousand cSt (such as bonker C and heavy emulsions).

Another method of treating an oil spill is in-situ burning/open burning. In this method, the oil is burned to remove the oil from the ocean water. Studies have found that burning oil spills are generally more efficient than mechanical oil recovery. However, the conditions for burning the oil spill must be very specific. For example, the spilled oil must be at least three millimeters thick and relatively fresh. Oil spills that are weathered or emulsified may not be removed by burning. Also, burning oil is not effective in high winds (i.e., greater than 30 knots). Burning oil spills also has other deficiencies such as the production of toxic chemicals such as zinc, vanadium, lead, nickel, also soot and polynuclear aromatic hydrocarbons. These toxic chemicals affect human health and welfare in that they may cause cancer and mutations in living tissue. Acid rain may also be produced as a result of in-situ burning.

Generally burning oil is practiced in remote open ocean areas and is subject to restrictions by federal, state and local laws as well as being regulated by the Environmental Protection Agency (EPA).

There are also various shoreline cleanup techniques that require extensive manual labor. They require the use of graters, scrapers, front end loaders, clamshell, high pressure flushing (hydro-blasting), steam cleaning, sandblasting, manual scraping, vacuum pumps, low pressure flushing, manual removal of oiled materials, burning and other toxic equipment. These manual methods impact the environment physically such as in the removal of sediment, generation of suspended sediments caused by disruption thereof by the above-mentioned machines, removal of all organisms and nutrition and erosion of shorelines.

The most effective and harmless method is natural recovery. In natural recovery, no action is taken. Nature in its own time cleans up the oil spill. Unfortunately, nature takes an extremely long time to clean up the oil spill. Moreover, certain areas are not conducive to clean up by nature. It is also not easy to determine whether a particular site can be naturally recovered. Accordingly, even though a site may be a candidate for natural recovery, it cannot be known whether such site will be cleaned up by nature itself.

Another method is bioremediation. Unfortunately, bioremediation may take weeks to months. Moreover, the bioremediation technique is still in the research and development stage and is not considered as an immediate response tool.

### BRIEF SUMMARY

The apparatuses discussed herein addresses the needs discussed above, discussed below and those known in the art.

A first embodiment of the apparatus comprises a twin hull water vessel. A sprayer operative to spray molten wax between the hulls of the vessel may be mounted to the vessel at a bow of the vessel. A take up system may be mounted at the aft of the vessel. After the molten wax is sprayed on the water, the wax solidifies into chunks of wax with oil entrained therein. The chunks are picked up by the take up system. The take up system picks the chunks of wax/oil from the water and delivers the same to a separation system wherein the oil, water and wax are separated. The oil may be stored in collecting bladders and off loaded for immediate pick up and removal or transported off of the vessel for further refinement into fuel. The wax is transferred to a buffer and stored for further reuse to pick up more oil. The excess water is returned to the ocean or body of water.

A second embodiment of the apparatus may comprise a removeably attachable heater/sprayer. The apparatus may be mounted to a small twin hull vessel such as a catamaran for recovering smaller spills.

A third embodiment of the apparatus may be effective in recovering oil spilled on land. The apparatus may comprises a truck and a trailer. The trailer may be mounted with a sprayer, take up system, separation system and buffer. The sprayer may be mounted to a forward portion. The take up system may be mounted to a rearward portion of the trailer. The sprayer sprays molten wax on spilled oil. The wax solidifies entraining the oil into chunks of oil and wax. The take up system may pick up the chunks off of the ground and deliver the same to a separation system to separate the oil from the wax.

A fourth embodiment of the apparatus may be a personal unit. The personal unit may be hand held such that recovery team personnel may spray molten wax on spilled oil. The molten wax solidifies then entrains the spilled oil therein. The solidified wax may be picked up manually or automatically for subsequent disposal (e.g., separation of wax and oil or thrown away).

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a first embodiment of an apparatus for recovering oil;

FIG. 2 is a top view of the apparatus of FIG. 1;

FIG. 3 is a side view of the apparatus of FIG. 2;

FIG. 4 is a perspective view of a sprayer mounted to the apparatus shown in FIG. 1;

FIG. 5 is a perspective view of a take up system and grinder mounted to the apparatus shown in FIG. 1;

FIG. 5A is a side view of the take up system shown in FIG. 5;

FIG. 6 is a perspective view of the grinder shown in FIG. 5;

FIG. 7 is a perspective view of a mesh belt shown in FIG. 3;

FIG. 8 is a perspective view of a distillation tower shown in FIG. 3;

FIG. 9 is a top cross sectional view of the distillation tower shown in FIG. 8;

FIG. 10 is a perspective view of a buffer shown in FIG. 3;

FIG. 11 is a perspective view of a cold wax storage tank;

FIG. 12 is a side cross sectional view of a second embodiment of the apparatus for recovering oil;

FIG. 13 is a side cross sectional view of a third embodiment of the apparatus for recovering oil;

FIG. 14 is a side cross sectional view of a fourth embodiment of the apparatus for recovering oil; and

FIG. 15 is a perspective view of a plurality of apparatuses shown in FIG. 14 mounted to a hook on a wall.

### DETAILED DESCRIPTION

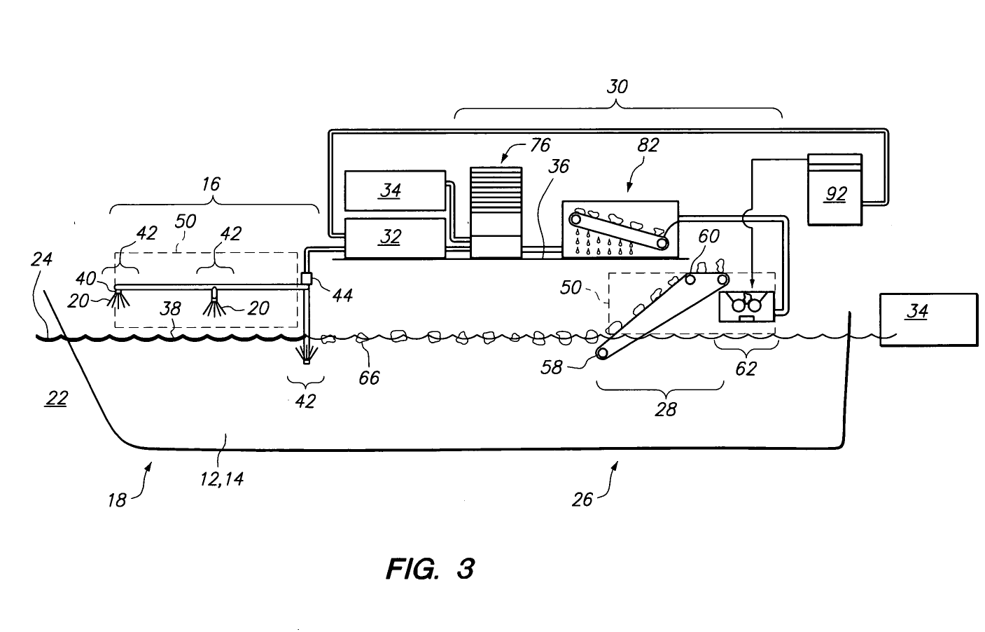

Referring now to the drawings, the same illustrate four different apparatuses for recovering oil spilled on land or in water (e.g., sea). The apparatuses may be used in conjunction with the method disclosed in U.S. Pat. No. 5,112,495, the entire contents of which are incorporated herein by reference. An apparatus for recovering oil spilled at sea may comprise a host vessel 10 having parallel and aligned first and second hulls 12, 14. The first and second hulls 12, 14 may be partially submerged in the water, as shown in FIG. 3. If the oil spill occurred in the open ocean, the first and second hulls 12, 14 may create a calm water surface therebetween 12, 14. As the host vessel 10 moves forward, a sprayer 16 located at a bow 18 (see FIGS. 2 and 3) of the host vessel 10 may spray molten wax 20 over the surface 38 (see FIG. 3) of the water 22. The wax 20 solidifies and traps the spilled oil 22 as chunks 66 (see FIG. 3). The host vessel 10 continues to move forward with the chunks 66 of solidified wax 20/spilled oil 24 approaching the aft 26 (see FIG. 3) of the host vessel 10. A take-up system 28 may be attached to the host vessel 10 at the aft 26 of the host vessel 10. The take-up system 28 collects the chunks 66 of solidified wax 20/oil 24 and delivers the chunks 66 to a separation system 30. The separation system 30 separates the wax 20 from the oil 24. The wax 20 may be delivered to a buffer 32 for reuse and the oil may be delivered to a collecting bladder 34. Beneficially, the oil 24 delivered to the collecting bladder 34 is not toxic waste but may be subsequently refined for fuel. The host vessel 10 may methodically cover a contaminated area until the spilled oil is recovered.

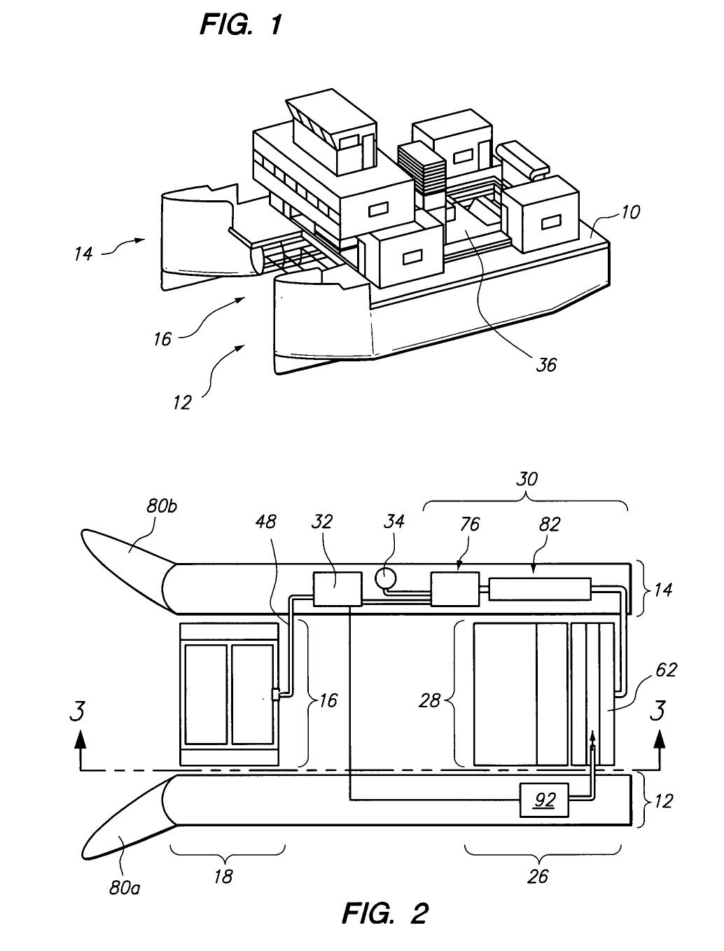

The host vessel 10 may be a twin hull vessel such as a small water area twin hull or a catamaran type vessel. The first and second hulls 12, 14 of the host vessel 10 may be submerged under water about two (2) to about nine (9) feet. The hulls 12, 14 may define a longitudinal axis and be aligned to a forward direction of the host vessel 10. A body 36 (see FIG. 1) of the host vessel 10 may be fixedly attached to the first and second hulls 12, 14. Moreover, the body 36 may be gapped above the surface 38 of the water 22, as shown in FIG. 3. The host vessel 10 during the contaminant recovery operation may travel forward with a speed of approximately one (1) to two (2) knots.

The sprayer 16 may float on the water 22 independent from the host vessel 10. The independent floatation of the sprayer 16 from the host vessel 10 provides for even distribution of molten wax 20 on the surface 38 of the water 22. The reason is that the sprayer 16 being lighter than the host vessel 10 may react to waves and other water disturbances quicker compared to the host vessel 10. Moreover, the sprayer 16 may react with a close one (1) to one (1) correspondence with waves and/or other water surface 38 disturbances to maintain a constant distance between a spray nozzle 40 of the sprayer 16 to the surface 38 to the water 22. This provides for controlled distribution (e.g., even) of the molten wax 22 over the surface 38 of the water 22.

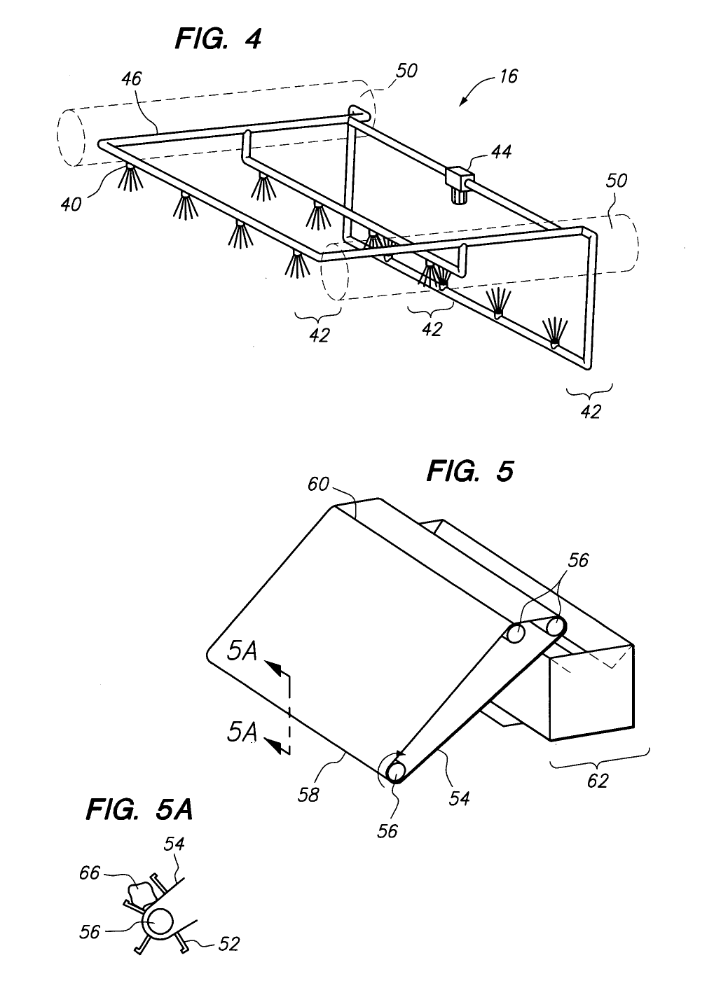

The sprayer 16 may comprise one or more sets of spraying clusters 42. Each of the spraying clusters 42 may comprise one or more spray nozzles 40. The spray nozzles 40 of the spraying clusters 42 may be directed toward the surface 38 of the water 22. By way of example and not limitation, the spray nozzles 40 may be directed generally perpendicular to the water surface 38. It is also contemplated that the spray nozzles 40 may be directed or pointed toward the forward direction, rearward direction or sideways of the host vessel 10 for the purpose of agitating the oil 24, providing even distribution of molten wax 20 on the water surface 38, and/or increasing oil 24 pickup by the solidified wax 20. Moreover, the spray nozzles 40 of the cluster 42 may be disposed above the surface 38 of the water 22. The spray nozzles 40 may be operative to spray molten wax on the water substantially from hull 12 to hull 14. Molten wax 20 may enter a manifold 44 and be distributed to the spraying clusters 42 via a frame 46 (see FIG. 4) of the sprayer 16. The frame 46 may be interconnected hollow tubes which fluidly connect the spray nozzles 40 to the manifold 44. The hollow tubes may be heated to maintain the molten state of the molten wax 20. In the alternative, the frame 46 may be a solid or hollow frame. The molten wax 20 may enter the manifold 44 but be connected to the spray nozzles 40 with a heated hose (not shown).

The sprayer 16 may float upon the water with the aid of one or more flotation devices 50. The floatation devices 50 may be attached to the frame 46 and may maintain some of the spray nozzles 40 above the surface 38 of the water 22 and/or some of the spray nozzles 40 below the surface 38 of the water.

The molten wax 20 may be sprayed out of the spray nozzles 40 at high pressure or low pressure. The pressure at which the molten wax 20 is sprayed out of the spray nozzles may be adjusted until the molten wax 20 optimally penetrates the surface 38 of the water to mix the molten wax 20 and the spilled oil together.

Optionally, at least one of the spraying clusters 42 may be submerged beneath surface 38 of the water 22, as shown in FIG. 3. The spray nozzles 40 of the submerged spring cluster 42 may be directed upwards, namely, perpendicular to the water surface 38, forward, rearward or sideways. When the molten wax 20 is sprayed out of the spray nozzles 40 of the submerged spraying cluster 42, the molten wax 20 sprayed out of the spraying nozzles 40 agitates the oil and mixes with the oil.

The first and second hulls 12, 14 of the host vessel 10 may calm the surface 38 of the water 22 therebetween 12, 14. The oil 24 (see FIG. 3) being lighter than the water 22, tends to float on the water 22 (see FIG. 3). The first and second hulls 12, 14 prepare the contaminated water 22 for treatment by calming the water surface 38. The host vessel 10 moves forward at approximately one (1) to two (2) knots. Molten wax 20 may be sprayed onto the surface 38 of the water 22. Also, molten wax 20 may be sprayed below the surface 38 of the water 22. The force of the sprayed molten wax 20 and the molten wax 20 sprayed under the surface 38 of the water 22 agitates the floating oil to mix the molten wax 20 and the oil together.

As shown in FIG. 3, as the host vessel 10 moves forward, the molten wax 20 begins to solidify into chunks 66 of oil 24 and wax 20. The chunks 66 of solidified wax 20/oil 24 may be lighter than the water. As such, the chunks 66 may float. The floating chunks 66 of solidified wax 20/oil 24 may approach the aft 26 of the host vessel 10.

The take-up system 28 may be located at the aft 26 of the host vessel 10. Similar to the sprayer 16, the take-up system 28 may independently float on the surface 38 of the water 22 from the host vessel 10. The independent floatation of the take-up system 28 may be accomplished with floatation device 50. The take-up system 28 may be a conveyor system. The conveyor system may comprise a conveyor belt 54 and a plurality of rollers 56, as shown in FIG. 5. The rollers 56 may provide tension to the conveyor belt 54 and rotate the conveyor belt 54 to provide motion to the conveyor belt 54. The rollers 56 may rotate in the direction shown in FIG. 5 such that the conveyor belt 54 may pick up solidified wax 20/oil 24 from the water 22. In particular, the take up system 28 may define a leading edge 58. The leading edge 58 may be submerged below the surface 38 of the water 22, as shown in FIG. 3. The exterior surface of the conveyor belt 54 may have protrusions 52 (see FIG. 5A) which help bring up the chunks 66 of wax 20/oil 24. The protrusions 52 may have a hook configuration, as shown in FIG. 5A. The take up system 28 may substantially extend the distance between the hulls 12, 14. As the conveyor belt 54 moves, the protrusions 52 pick up the chunks 66 of wax 20/oil 24 from underneath the surface 38 of the water. As the chunks move up on the conveyor belt 54, water drips off of the chunks 66 and drips back into the ocean. The oil is trapped in the chunks 66 of solidified wax 20 and delivered to the separation system 30 (see FIG. 3).

The take-up system 28 may also be attached to floatation devices 50 (see FIG. 3) that allow the leading edge 58 of the take-up system 28 to be submerged below the surface 38 of the water 22 despite waves and other disturbances in the water surface 38. Also, the floatation devices 50 allow the upper edge 60 of the take up system 28 to be above the surface 38 of the water 22 despite waves and other disturbances in the water surface 38.

Both the sprayer 16 and the take up system 28 may independently float on the water surface 38 from the host vessel 10 and from each other. The sprayer 16 and the take-up system 28 may be attached to the host vessel 10 between the first and second hulls 12, 14 in a manner that permits the sprayer 16 and the take-up system 28 to react vertically to waves and other surface disturbances. For example, if a wave approaches and hits the sprayer 16 or the take-up system 28, the floatation devices 50 attached to the sprayer 16 and the take up system 28 raises the sprayer 16 and the take-up system 28 such that the spray nozzles 40 maintain their distance to the surface 38 of the water 22 and the leading edge 58 of the take-up system 28 remains submerged below the surface 38 of the water 22 and the upper edge 60 of the take up system 28 remains above the surface of the water. As the host vessel 10 moves forward, the water surface 38 may drop. The floatation devices 50 attached to the sprayer and/or the take-up system 28 reacts to drop the elevation of the sprayer and take-up system 28 to maintain the position of the sprayer 16 and take-up system 28 to the water surface 38. The sprayer 16 and the take-up system 28 may be pushed forward or pulled forward by the host vessel 10 as the host vessel 10 moves forward.

The separation system 30 may comprise a grinder 62 (see FIGS. 2, 3, 5 and 6). The grinder 62 may be disposed after the take up system 28, as shown in FIG. 5. The take-up system 28 may pick up the chunks 66 of wax 20/oil 24 and deliver the same to the grinder 62. The grinder 62 may comprise two barriers 64a, b which guide the chunks 66 between counter rotating cylinders 68a, b. The counter rotating cylinders 68a, b squeeze the solidified chunks 66 to free any water entrapped in the chunks 66. First and second conveyor belts 70a, b may direct the squeezed chunks 66 to an intake 72 of a sludge pump 74.

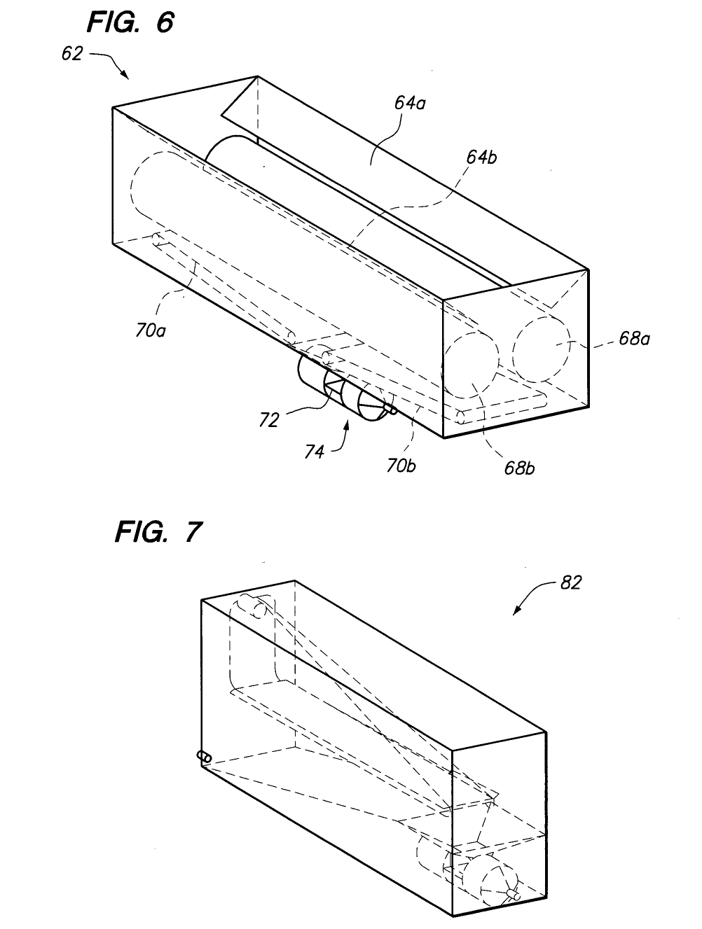

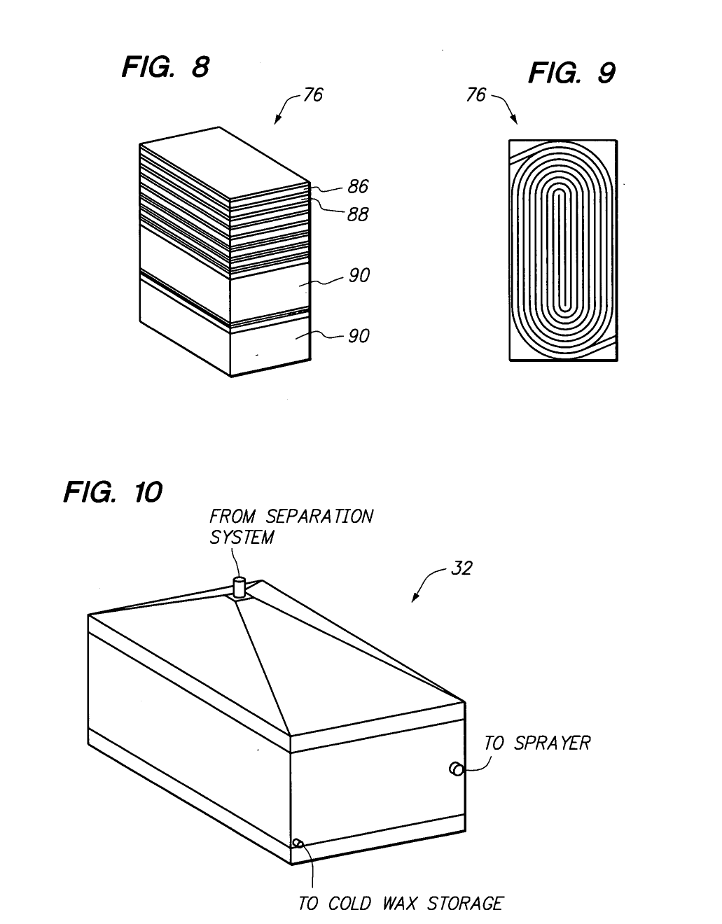

The sludge pump 74 (see FIG. 6) may deliver the crushed chunks 66 and water onto a moving mesh belt 82 (see FIGS. 3 and 7) which allows the water droplets to drip off of the crushed chunks 66, as shown in FIG. 3. The water is returned to the ocean. The chunks 66 then enter into a heater exchanger-distillation tower 76 (see FIGS. 3, 8 and 9). The distillation tower 76 may comprise twelve (12) or more interlocking heaters 86 and circulator 88 sections wherein the heater 86 and material circulator 88 alternates, as shown in FIG. 8. To increase the heating efficiency, each section may recirculate the material to utilize heat exchanging, as shown in FIG. 9. The chunks 66 may be pre-heated to approximately 200° F. to remove light fractionate. The lower serially connected sections increase the temperature of the chunks to remove all components except for the wax 20. The wax then enters the next taller section which is a buffered and self-circulated spraying box 90. This section 90 raises the wax temperature to around 520° F. for distilling lighter parts. Subsequently, the wax 20 is then raised to approximately 600° F. or just above the wax's boiling point so the wax could be condensed, cooled and used again. The other components (i.e., oil) are pumped into the collecting bladder 34.

The collecting bladders 34 may be removed from the host vessel 10 and left in the water 22, as shown in FIG. 3. Preferably, the collecting bladders 34 may float such that a separate utility boat may shuttle the collecting bladders 34 from the ocean to the land or a separate oil tanker. The oil in the collecting bladders 34 may then be refined for fuel. The host vessel 10 may continue to recover the contaminant with the process discussed above.

Optionally, the host vessel 10 may have containment booms 80a, b (see FIG. 2) which are attached to the bow 18 of the first and second hulls 12, 14. The containment booms 80a, b may have a V-shape when viewed from the top, as shown in FIG. 2. This allows more oil to be funneled into or between the first and second hulls 12, 14. More particularly, the distal ends of the containment booms 80a, b may be skewed outward with respect to the first and second hulls 12, 14. Moreover, the containment booms 80a, b may be submerged below the surface 38 of the water 22. As the host vessel moves forward, more oil may be directed under the sprayer 16 and between the first and second hulls 12, 14.

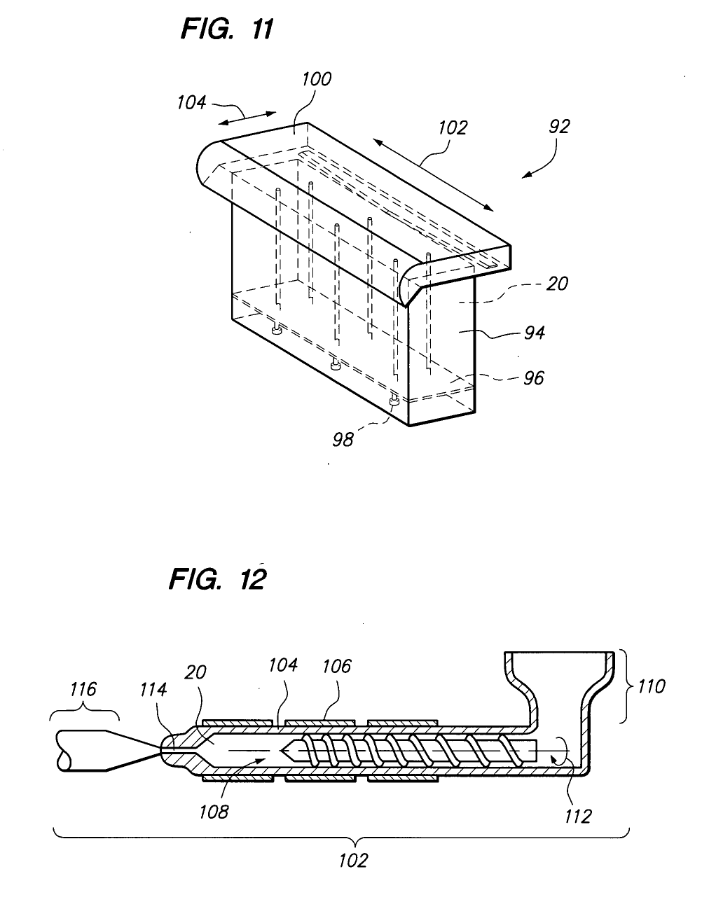

Referring now to FIG. 11, a standby cold wax tank 92 (see also FIG. 3) is shown. The cold wax tank 92 may be sized to hold approximately twenty (20) tons of wax. The cold wax tank 92 may have a container 94. A platform 96 may be disposed below the solid wax 20. The solid wax 20 may be raised upward by raising the platform 96 by turning the lead screws 98. As the platform 96 and wax 20 are raised upward, a knife 100 may be reciprocated to slice the wax into smaller portions. The knife 100 may be reciprocated in the longitudinal direction of the cold wax tank 92 as shown by arrows 102 in FIG. 11. Alternatively, the knife 100 may reciprocate in the lateral direction as shown by arrow 104 in FIG. 11. At startup, as shown in FIGS. 2 and 3, the cold wax tank 92 may deliver small portions of wax 20 into the grinder 62. The solid wax 20 is ultimately delivered to the distillation tower 76 for melting and storage in the heated buffer 32 (see FIG. 10) for delivery to the spilled oil via the sprayer 16.

At shutdown, the molten wax in the heated buffer 32 is transferred to the cold wax storage 92. In particular, the lead screws 98 rotate to lower the platform 96 and the level of the solid wax 20 in the tank 94. The molten wax from the buffer 32 is then transferred to the cold wax storage 92 for later use.

Referring now to FIG. 12, an apparatus 102 for spraying molten wax 20 on spilled oil 24 is shown. The apparatus 102 may comprise a body 104, heaters 106, a modified extrusion screw 108 and a hopper 110. Solid wax 20 may be introduced into the hopper 110. As the screw 108 rotates in the direction 112 shown in FIG. 12, the solid wax 20 is forced forward into the body 104. The heaters 106 heat the wax as the wax traverses toward the front of the body 104. When the wax 20 reaches the front portion of the body 104, the wax is in the molten state. Moreover, the threads of the screw 108 may have a pitch which decreases as the threads approach the front portion of the body 104. This is to increase the pressure of the molten wax 20 located at the front of the body 104. The molten wax 20 may be ejected out of the exit opening 114 and be transferred to a heated pipe 116 to maintain the molten state of the wax 20. The molten wax 20 may also be delivered to a sprayer 16 for spraying the molten wax onto spilled oil. The apparatus 102 may be mounted onto a small vessel (e.g., catamaran) for recovering small oil spills. It is also contemplated that the apparatus 102 may be mounted onto the trailer 200 discussed below. It is contemplated that the hopper 110 may be replaced with a wax cutter or grinder which delivers small portions of solid wax to the entrance of the body 104. The apparatus 102 including the rotating speed of the screw 108 may be sized and configured so as to produce about one (1) to about five (5) gallons of wax per minute for spraying.

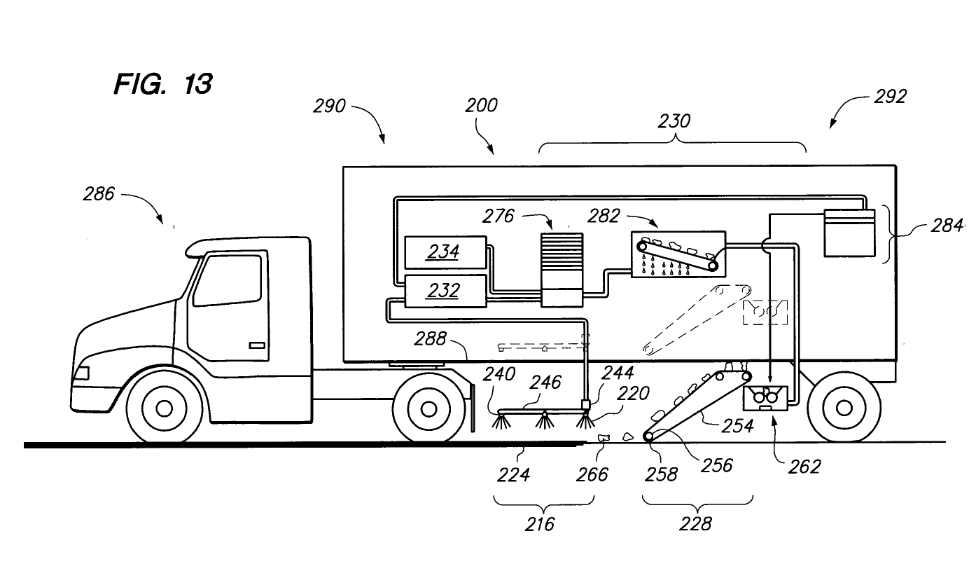

In another embodiment, an apparatus for recovering oil spilled on land is contemplated. In FIG. 13, a trailer 200 may be mounted with a sprayer 216, take-up system 228, separation system 230, buffer 232 and collecting bladder 234. Also, a cold wax storage 284 may be mounted to the trailer 200. These components may comprise the contaminant recovery system. The trailer 200 may be self-powered or pulled via a truck 286. The trailer 200 under the power of the truck 286 may pass back and forth over an oil spill. As the truck passes over the oil spill, the contaminant recovery apparatus sprays molten wax 220 on the spilled oil 224 which subsequently solidifies and entrains the spilled oil 224 in the solidified wax 220 as chunks 266. The take up system 228 picks up the chunks 266 of wax 220/oil 224 and delivers the chunks 266 to the separation system 230 which separates the oil 224 from the wax 220. The oil 224 is transferred to the collecting bladder 234. The wax 220 is transferred to the buffer 232 for reuse.

The trailer 200 may have a flat workbed 288. The sprayer 216, take-up system 228, separation system 230, buffer 232, and cold wax storage 284 may be mounted to the workbed 288. Optionally, the collecting bladders 234 may be removably attachable to the workbed 288. These components, namely, the sprayer 216, the take-up system 228, the separation system 230, the buffer 232, the collecting bladder 234 and the cold wax storage 284 may be mounted to the workbed 288 such that the components may be transported over local roads, highways and/or streets. The separation system 230, the buffer 232 and the cold wax storage 284 may be fixedly mounted to the workbed. The sprayer 216 and the take-up system 228 may be also fixedly engaged to the workbed 288 but it is also contemplated that they 216, 228 may be traversable between an extended position (shown in solid lines in FIG. 13) and a retracted position (shown in phantom lines in FIG. 13). In the retracted position, the trailer 200 is operative to transport the contaminant recovery system between short or long distances. In the extended position, the sprayer 216 and the take-up system 228 are traversed adjacent the ground and operative to spray wax 220 on oil and pick up the chunks 266 of oil and wax.

The sprayer 216 may be attached to the workbed 288 at a forward portion 290 of the workbed 288. The sprayer 216, as discussed above, is traversable between the retracted position and the extended position. The sprayer 216 may be rotated to the extended position when in use. The sprayer 216 may comprise a plurality of spray nozzles 240 attached to a frame 246. The spray nozzles 240 may be operative to spray molten wax 220 over the oil spill when the sprayer 216 is in the extended position. The frame 246 may be hollow to provide fluid connection between a manifold 244 and each of the spray nozzles 240. In this instance, the frame 246 may be heated to maintain the molten state of the wax 220. As the trailer 200 traverses over the oil spill, the sprayer 216 may spray molten wax 220 on the surface of the oil spill. The molten wax 220 may be sprayed on the oil spill at various pressures. For example, the molten wax 220 may be sprayed on the oil spill at high pressure to disrupt the oil spill and mix the wax 220 with the oil. After the molten wax 220 is sprayed on the oil spill, the molten wax is solidified into chunks 266 of wax 220 and oil 224.

The take-up system 228 may be attached to the rearward portion 292 of the workbed 288. The take-up system 228 may be a conveyor system. A conveyor belt 254 of the take-up system 228 may be placed in tension by rollers 256. A leading edge 258 of the take-up system 228 may be positioned against or closely adjacent the ground when the take-up system 228 is in the extended position. The leading edge 258 of the take-up system 228 may be pointed toward the forward direction of the trailer 200 and operative to scrape the chunks 266 off of the ground and onto the conveyor belt 254. More particularly, the conveyor belt 254 may have a plurality of hooks sized and configured to pick the chunks 266 off of the ground and onto the conveyor belt 254. It is also contemplated that the take up system 228 may be a vacuum.

The conveyor system delivers or transfers the chunks 266 from the ground to the separation system 230. The separation system 230 may comprise a heat exchangers-distillation tower 276. The heat exchanger-distillation tower 276 separates the wax 220 from the oil 224. The separated wax 220 may be delivered to the buffer 232 for respraying onto the spilled oil. Also, the recovered oil 224 may be transferred to collecting bladders 234. The collecting bladders 234 may be removably attachable to the workbed 288. Once the collecting bladder 234 is filled with oil 224, the collecting bladder 234 may be off loaded onto the ground for separate pickup by a utility vehicle. The trailer 200 may continue to traverse across the area of the oil spill while the utility vehicle shuttles the filled collecting bladders 234 to a separate location for delivery to a refinery such that the collected oil may be refined for fuel. The utility vehicle may also deliver empty collecting bladders 234 to the trailer 200 for subsequent use.

Optionally, the separation system 230 may also comprise a grinder 262. The grinder 262 may be disposed behind the conveyor system 252. The grinder 262 may operate in a similar manner compared to the grinder 62 discussed above. After the grinder 262 has crushed the chunks 266, the crushed chunks 266 may be transferred to the optional mesh belt 282 and/or heat exchanger-distillation tower 276 for separating the oil 224 and the wax 220.

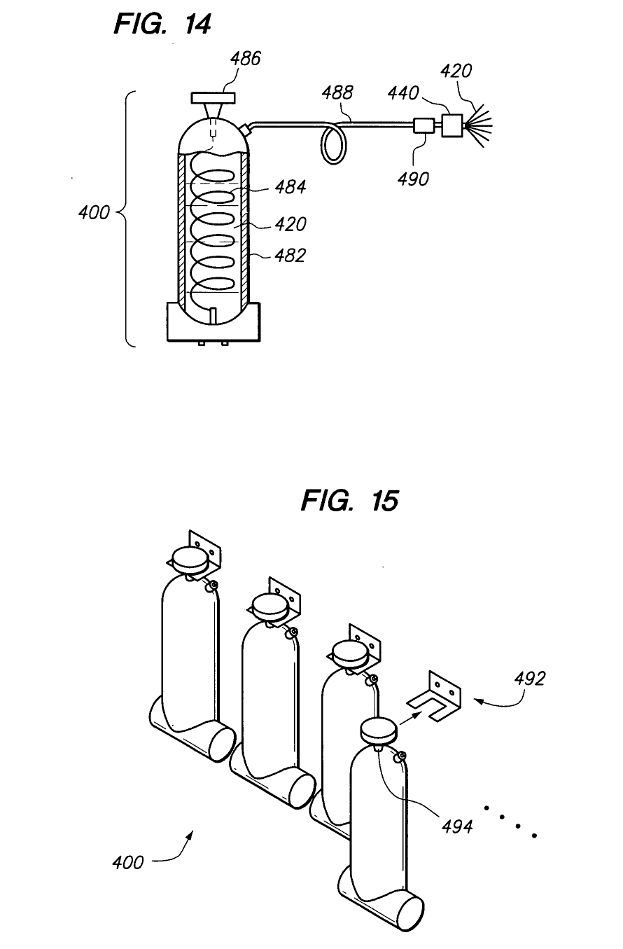

In another embodiment, the contaminant recovery system may be used for very small spills of oil, as shown in FIGS. 14 and 15. For example, the contaminant recovery system may comprise a hand held unit 400 for spraying molten wax 420. The molten wax 420 once sprayed onto the oil spill may solidify into chunks and entrain the oil in the chunks. The chunks may then be scraped up manually (e.g., shovel, vacuum). The chunks may be disposed of as toxic waste or sent to a separation system for separating the wax and the oil.

The hand held unit 400 may comprise a tank 482. The tank may hold molten wax 420. The wax 420 may be maintained in the molten state via a heater 484 disposed within the tank 482. The heater 484 may be an electrical heater supplied with power by a generator, or an electrical outlet. The tank 482 may also have a handle 486 such that the user may carry the tank 482 with one hand. The hand held unit 400 may also have a spray nozzle 440 through which the molten wax 420 is ejected and sprayed onto the oil spill. The spray nozzle 440 may be in fluid communication with the tank 482 via a heated hose 488. The spray nozzle 440 may be controlled with a control valve 490. For example, the spray nozzle 440 may be opened and closed with the control valve 490. Also, the amount and pressure of the molten wax 420 flowing through the spray nozzle 440 may be controlled with the control valve 490. The spray nozzle 440 and the tank 482 may be in fluid communication with each other via a heated hose 488. The tank 482 may be pressurized to eject molten wax 420 out of the spray nozzle 440.

Once a spill is detected, the user may walk around the oil spill while holding the hand held unit 400. The user sprays molten wax 420 on the oil spray thereby entraining the oil into the solidified wax 420 as chunks 466. The user may then scrape up the chunks 466 for subsequent toxic disposal or separation of oil 424 and wax 420.

In an aspect of the hand held unit 400, it is contemplated that the tank 482 may be insulated. The hand held unit 400 may have back pack straps such that the user may carry the hand held unit 400 on his/her shoulders and operate the spray nozzles 440 with his/her hand.

In an aspect of the hand held unit 400, it is contemplated that a plurality of hand held units 400 may be attached to a wall with a hook 492. For example, the neck 494 hand held unit 400 may be hung on the hook 492. When an oil spill occurs, a large number of personnel may utilize the hand held units 400 by detaching the hand held units from the hooks 492 and spraying molten wax 420 on the oil spill.

The wax described above may be a hydrocarbon wax, preferably a paraffin wax. It is also contemplated that the hydrocarbon wax may be microcrystalline wax. The hydrocarbon wax may be different configurations of carbon and hydrogen in “straight-chain” molecules containing from about eighteen (18) to seventy (70) carbon atoms/molecules, and roughly twice as many hydrogen atoms. Preferably, the paraffin and microcrystalline waxes range from C18-H38 to C38-H66 and solidify between 80.5° F. and 220° F. A paraffin wax is a petroleum wax, recovered from paraffin distillate which consists principally of normal alkalines; petrolatum; and petroleum ceresin group. Semicrystalline, microcrystalline and amorphous waxes are also petroleum waxes that contain substantial proportions of hydrocarbons other than normal alkalines. The oil described above is preferably a petroleum based oil.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A water vessel for recovering contaminant spilled in water, the vessel comprising:
first and second containment walls each defining a longitudinal axis, the longitudinal axes of the first and second containment walls aligned to a forward direction of the vessel and parallel to each other, the first and second containment walls at least partially submerged in the water;
a sprayer disposed between the first and second containment walls and adjacent a forward portion of the first and second containment walls for delivering a recovery material to the water;
a take up system for removing the mixed recovery material and contaminant from the water, the take up system disposed between the first and second containment walls and adjacent a rearward portion of the first and second containment walls.

2. The vessel of claim 1 further comprising a separation system attached to the vessel for separating the contaminant recovery material and the spilled contaminant.

3. The vessel of claim 1 wherein the sprayer is suspended independently on the water separate from the vessel for maintaining a constant distance between spray nozzles of the sprayer to a surface of the water despite waves and water surface disturbances.

4. The vessel of claim 1 wherein the take up system is suspended independently on the water separate from the vessel for maintaining a leading edge of the take up system beneath a surface of the water and maintaining a trailing edge of the take up system above the surface of the water.

5. The vessel of claim 1 wherein the first and second containment walls are left and right hulls of a boat.

6. The vessel of claim 1 wherein the recovery material is wax and the contaminant is oil.

7. The vessel of claim 1 further comprising containment booms disposed in front of the first and second containment walls, the containment booms being skewed outwards for directing more oil between the first and second containment walls.

8. The vessel of claim 1 further comprising a collecting bladder attached to the vessel for storing the contaminant.

9. The vessel of claim 9 wherein the collecting bladder is removable from the vessel.

10. An apparatus for spraying a recovery material on spilled oil, the apparatus comprising:
a hollow body defining a front portion and a rear portion;
a screw rotateably disposed within the hollow body, the screw having threads having a pitch which decreases as the threads approach the front portion of the hollow body;
wax disposed within the hollow body; and
heaters disposed on the hollow body for melting the wax.

11. The apparatus of claim 10 further comprising a wax cutter adjacent the rear portion of the hollow body.

13. A mobile land based unit for recovering contaminant spilled on land, the mobile land based unit comprising:
a mounting area traversable over land in a forward direction;
a sprayer attached to a forward portion of the mounting area and operative to spray a recovery material on the contaminant spilled on the land for mixing the recovery material and the contaminant spilled on the land;
a take up system attached to the mounting area for picking up the mixed recovery material and contaminant off of the land, the take up system attached to a rearward portion of the mounting area for picking up the mixture of recovery material and contaminant as the mounting area is traversed in the forward direction.

14. The unit of claim 13 further comprising a separation system attached to the mounting area for separating the recovery material and the spilled contaminant.

15. The unit of claim 13 wherein the sprayer is traversable between a retracted position for permitting the mounting area to be relocated to a different location and an extended position for permitting the sprayer to deliver the recovery material to the contaminant spilled on the ground.

16. The unit of claim 13 wherein the take up system is traversable between a retracted position for permitting the mounting area to be relocated to a different location and an extended position for permitting the take up system to retrieve the mixture of recovery material and contaminant off of the ground.

17. A sprayer for dispersing a recovery material on contaminant spilled on land, the sprayer comprising:
a recovery material combinable with the contaminant;
a tank for holding the recovery material, the recovery material disposed within the tank;
a hand manipulatable spray nozzle in fluid communication with the tank, the spray nozzle operative to delivery fluid to the spilled contaminant;
a heated hose fluidly connected to the spray nozzle and the tank for maintaining the wax in a molten state.

18. The sprayer of claim 17 wherein the recovery material is wax.
